(19) United States
(12) Patent Application Publication
(10) Pub. No.: US 2005/0107115 A1
(43) Pub. Date: May 19, 2005

(54) Mobile multimode terminal with joint power amplifier

(75) Inventor: Raymond H Wu, Xi'An (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/504,750

(22) PCT Filed: Jan. 23, 2003
(86) PCT No.: PCT/IB03/00192

(30) Foreign Application Priority Data
Feb. 20, 2002 (EP) 02075686.2

(51) Int. Cl. H04B 1/44

(52) U.S. Cl. 455/552.1; 455/78; 455/83; 455/158.1

(57) ABSTRACT

Mobile multimode terminals for use in frequency division modes and time division modes comprise a transmitter per mode. By providing both transmitters with one joint power amplifier (9) and one joint pre-amplifier (23), a terminal becomes more low cost. Additional advantages are reductions of complexity, power consumption and terminal size/weight. Both transmitters are coupled to a joint antenna (41), via a first mode switch (1) and a second mode switch (5) for distinguishing (switching) between both modes and distinguishing (switching) per mode between transmitting and receiving. A duplexer (7) located between both mode switches (1,5) allows the transmitting and receiving in said frequency division mode, and a time slot switch (3) allows the selection of transmitting time slots and of receiving time slots in said time division mode. Said terminals further comprise a receiver for each mode, with both receivers comprising a joint variable gain amplifier (26). A joint Phase Locked Loop system (19,20,24,25) supplies all mixers (14,15,6,17).

The invention relates to a mobile multimode terminal for use in at least a first frequency division mode and a second time division mode and comprising at least a first transmitter for transmitting first signals in said first frequency division mode and a second transmitter for transmitting second signals in said second time division mode.

The invention also relates to a transmitter system for use in a mobile multimode terminal for use in at least a first frequency division mode and a second time division mode, which mobile multimode terminal comprises said transmitter system comprising at least a first transmitter for transmitting first signals in said first frequency division mode and a second transmitter for transmitting second signals in said second time division mode, and to a method for use in a mobile multimode terminal for use in at least a first frequency division mode and a second time division mode, which method comprises the steps of transmitting first signals in said first frequency division mode and of transmitting second signals in said second time division mode.

Said first frequency division mode for example corresponds with UTRA/FDD (UMTS Terrestrial Radio Access/Frequency Division Duplexing) and said second time division mode for example corresponds with TDD (Time Division Duplexing) like for example TD-SCDMA (Time Division—Synchronous Code Division Multiple Access).

A prior art mobile multimode (FDD/TDD) terminal is disclosed in the abstract of “UTRA TDD Protocol Operation” by Christina Geβner, Reinhard Köhn, Jörg Schniedenharn and Armin Sitte, published during the 11th IEEE International Symposium on Personal and Mobile Radio Communications PMRC 2000, vol. 2 pages 1226-1230.

Known mobile multimode (FDD/TDD) terminals are disadvantageous, inter alia, due to being low cost insufficiently.

It is an object of the invention, inter alia, of providing a mobile multimode terminal as defined in the preamble which is more low cost.

The mobile multimode terminal according to the invention is characterized in that said first and second transmitters comprise a joint power amplifier for amplifying said first and second signals.

By introducing one joint power amplifier for both transmitters, compared to the situation where there are two power amplifiers—one for each transmitter—now one power amplifier is saved, which makes the mobile multimode terminal more low cost.

The invention is based upon an insight, inter alia, that both modes (can) use the same, overlapping, neighboring and/or nearby frequency bands, and is based upon a basic idea, inter alia, that one joint power amplifier can be used in case of both modes not being active at the same moment.

The invention solves the problem, inter alia, of providing a low cost mobile multimode terminal, by deleting, of two or more power amplifiers, one or more power amplifiers which are superfluous.

Additional advantages of using one joint power amplifier instead of two or more are reductions of complexity, power consumption and terminal size/weight.

A first embodiment of the mobile multimode terminal according to the invention as defined in claim 2 is advantageous in that said first and second transmitters are coupled to a joint antenna.

By introducing one joint antenna for both transmitters, compared to the situation where there are two antennas—one for each transmitter—now one antenna is saved, which makes the mobile multimode terminal more low cost.

A second embodiment of the mobile multimode terminal according to the invention as defined in claim 3 is advantageous in that an output of said joint power amplifier is coupled to said joint antenna via a first mode switch and a second mode switch.

By introducing two mode switches between the output of the joint power amplifier and the joint antenna, the mobile multimode terminal can distinguish (switch) between both modes and couple one joint power amplifier to one joint antenna via different ways.

A third embodiment of the mobile multimode terminal according to the invention as defined in claim 4 is advantageous in that, in said first frequency division mode, main contacts of both mode switches are coupled to each other via a first filter and a duplexer, with, in said second time division mode, main contacts of both mode switches being coupled to each other via a second filter and a time slot switch.

The first filter is for example a bandpass filter having a bandwidth of for example 3.84 MHz, with said duplexer allowing the transmitting and receiving in said first frequency division mode. The second filter is for example a bandpass filter having a bandwidth of for example 1.28 MHz, with said time slot switch allowing the selection of transmitting time slots and of receiving time slots in said second time division mode.

A fourth embodiment of the mobile multimode terminal according to the invention as defined in claim 5 is advantageous in that an input of said joint power amplifier, in said first frequency division mode, is coupled to an output of a joint pre-amplifier via a third filter, a first mixer and a third mode switch, with said input of said joint power amplifier, in said second time division mode, being coupled to said output of said joint pre-amplifier via a fourth filter, a second mixer and said third mode switch.

The third filter is for example a bandpass filter having a bandwidth of for example 3.84 MHz, and the fourth filter is for example a bandpass filter having a bandwidth of for example 1.28 MHz. The third mode switch allows the use of said joint pre-amplifier for both transmitters. By introducing one joint pre-amplifier for both transmitters, compared to the situation where there are two pre-amplifiers—one for each transmitter—now one pre-amplifier is saved, which makes the mobile multimode terminal even more low cost.

A fifth embodiment of the mobile multimode terminal according to the invention as defined in claim 6 is advantageous in that said mobile multimode terminal comprises at least a first receiver for receiving third signals in said first frequency division mode and a second receiver for receiving fourth signals in said second time division mode, with an input of said first receiver being coupled to said joint antenna via said duplexer and said first mode switch, and with an input of said second receiver being coupled to said joint antenna via said time slot switch and said first mode switch.

For receiving said third and fourth signals, the first mode switch allows the distinguishment (switching) between both modes, with said duplexer and said time slot switch allowing the distinguishment (switching) between transmitting and receiving.

A sixth embodiment of the mobile multimode terminal according to the invention as defined in claim 7 is advantageous in that outputs of said first and second receivers are coupled to an input of a joint variable gain amplifier.

Both receivers are down-converted to for example the same Intermediate Frequency (IF). By introducing one joint variable gain amplifier for both receivers, compared to the situation where there are two variable gain amplifiers—one for each receiver—now one variable gain amplifier is saved, which makes the mobile multimode terminal even more low cost.

A seventh embodiment of the mobile multimode terminal according to the invention as defined in claim 8 is advantageous in that each receiver comprises a serial circuit of a low noise amplifier and a mixer located between filters.

Both filters in a first serial circuit for the frequency division mode are for example bandpass filters having a bandwidth of for example 3.84 MHz, and both filters in a second serial circuit for the time division mode are for example bandpass filters having a bandwidth of for example 1.28 MHz. In each serial circuit, the filter coupled to the low noise amplifier, inter alia, for example filters image frequency components, and the filter coupled to the mixer, inter alia, for example filters intermodulation components.

A eighth embodiment of the mobile multimode terminal according to the invention as defined in claim 9 is advantageous in that each mixer is coupled to a Phase Locked Loop system.

By introducing one joint Phase Locked Loop system for both transmitters as well as for both receivers, the efficiency of the mobile multimode terminal is further increased.

A ninth embodiment of the mobile multimode terminal according to the invention as defined in claim 10 is advantageous in that said Phase Locked Loop system comprises at least two Phase Locked Loops, with each Phase Locked Loop being coupled to at least one mixer.

A first Phase Locked Loop for example supplies the mixer in the first receiver (frequency division mode) and for example supplies the mixers in the second transmitter and second receiver (time division mode), and a second Phase Locked Loop for example supplies the mixer in the first transmitter (frequency division mode).

Embodiments of the transmitter system according to the invention and of the method according to the invention correspond with the embodiments of the mobile multimode terminal according to the invention.

These and other aspects of the invention will be apparent from and elucidated with reference to the embodiments(s) described hereinafter.

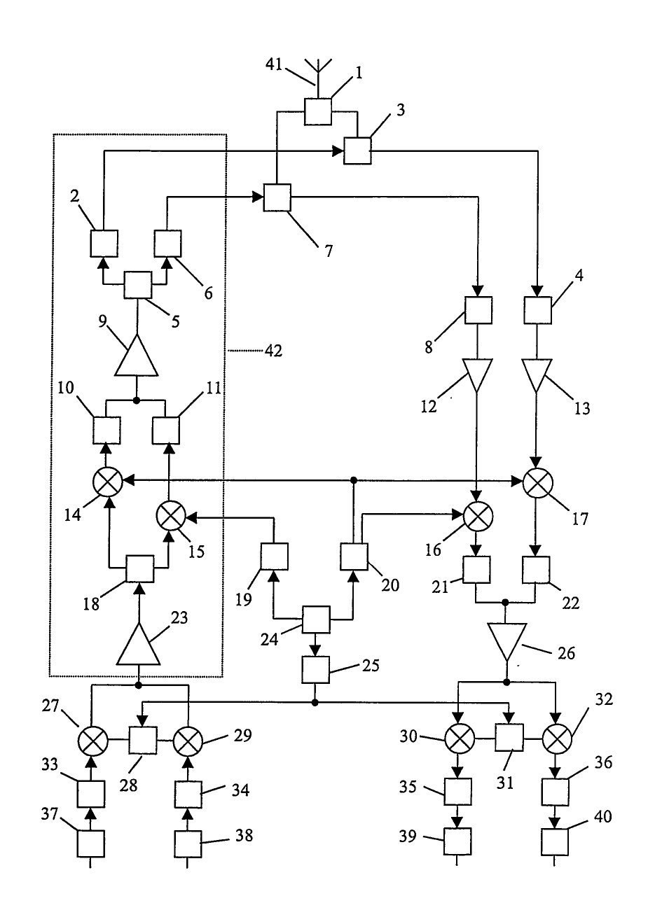

FIG. 1 illustrates in block diagram form a mobile multimode terminal according to the invention comprising a transmitter system according to the invention.

FIG. 1 discloses a mobile multimode terminal according to the invention (with “multimode” meaning “dual mode” or “tri mode” etc. with further modes and/or further submodes per one or more modes not to be excluded) comprising a first mode switch 1 of which a main contact is coupled to a joint antenna 41 and of which a first subcontact is coupled to a duplexer 7 and of which a second subcontact is coupled to a time slot switch 3. First mode switch 1 couples in response to a mode control signal said main contact to either said first subcontact (in case of said mode control signal for example having a first value) or to said second subcontact (in case of said mode control signal for example having a second value). An input of duplexer 7 is coupled to an output of first filter 6 for example being a bandpass filter, and an input of time slot switch 3 is coupled to an output of second filter 2. An input of first filter 6 is coupled to a first subcontact of second mode switch 5, and an input of second filter 2 is coupled to a second subcontact of second mode switch 5. A main contact of second mode switch 5 is coupled to an output of a joint power amplifier 9. Second mode switch 5 couples in response to said mode control signal said main contact to either said first subcontact (in case of said mode control signal for example having said first value) or to said second subcontact (in case of said mode control signal for example having said second value).

An input of power amplifier 9 is coupled to a first subcontact of third mode switch 18 via third filter 11 and first mixer 15 and is coupled to a second subcontact of third mode switch 18 via fourth filter 10 and second mixer 14. A main contact of third mode switch 18 is coupled to an output of a joint pre-amplifier 23. Third mode switch 18 couples in response to said mode control signal said main contact to either said first subcontact (in case of said mode control signal for example having said first value) or to said second subcontact (in case of said mode control signal for example having said second value). An input of joint pre-amplifier 23 is coupled to D/A converter 37 via mixer 27 and filter 33 for example being a low pass filter, and to D/A converter 38 via mixer 29 and filter 34 for example being a low pass filter.

An output of duplexer 7 is coupled to an input of filter 8 for example being a bandpass filter, and an output of time slot switch 3 is coupled to an input of filter 4 for example being a bandpass filter. An output of filter 8 is coupled via a low noise amplifier 12, a third mixer 16 and a filter 21 to an input of a joint variable gain amplifier 26, and an output of filter 4 is coupled via a low noise amplifier 13, a fourth mixer 17 and a filter 22 to said input of joint variable gain amplifier 26. An output of joint variable gain amplifier 26 is coupled to A/D converter 39 via mixer 30 and filter 35 for example being a low pass filter, and to A/D converter 40 via mixer 32 and filter 36 for example being a low pass filter.

Local oscillation inputs of second mixer 14 and fourth mixer 17 are coupled to a first output of a first Phase Locked Loop (PLL) 20, and a local oscillation input of third mixer 16 is coupled to a second output of first Phase Locked Loop (PLL) 20, and a local oscillation input of first mixer 15 is coupled to an output of a second PLL 19. Inputs of first PLL 20 and of second PLL 19 are coupled to a reference source 24, which is further used to drive a third Phase Locked Loop (PLL) 25, of which an output is coupled to a modulator 28 coupled to mixers 27 and 29 for I/Q modulation and to a demodulator 31 coupled to mixers 30 and 32 for demodulation.

The mobile multimode terminal according to the invention shown in FIG. 1 can be used in at least a first frequency division mode and a second time division mode and comprises at least a first transmitter 6,5,9,11,15,18,23 for transmitting first signals in said first frequency division mode and a second transmitter 2,5,9,10,14,18,23 for transmitting second signals in said second time division mode.

The transmitter system 42 according to the invention for use in a mobile multimode terminal for use in at least a first frequency division mode and a second time division mode, which mobile multimode terminal comprises said transmitter system, comprises at least a first transmitter 6,5,9,11,15,18,23 for transmitting first signals in said first frequency division mode and a second transmitter 2,5,9,10,14,18,23 for transmitting second signals in said second time division mode.

Said first frequency division mode for example corresponds with UTRA/FDD (UMTS Terrestrial Radio Access/Frequency Division Duplexing) and said second time division mode for example corresponds with TDD (Time Division Duplexing) like for example TD-SCDMA (Time Division—Synchronous Code Division Multiple Access).

It is an object of the invention, inter alia, of reducing the cost price of mobile multimode terminals.

The mobile multimode terminal according to the invention is characterized in that said first and second transmitters comprise a joint power amplifier 9 for amplifying said first and second signals.

By introducing one joint power amplifier 9 for both transmitters, compared to the situation where there are two separate power amplifiers—one for each transmitter—now one power amplifier is saved, which makes the mobile multimode terminal more low cost.

Additional advantages of using one joint power amplifier 9 instead of two or more are reductions of complexity, power consumption and terminal size/weight.

A first embodiment of the mobile multimode terminal according to the invention is advantageous in that said first and second transmitters are coupled to a joint antenna 41.

By introducing one joint antenna 41 for both transmitters, compared to the situation where there are two antennas—one for each transmitter—now one antenna 41 is saved, which makes the mobile multimode terminal more low cost.

A second embodiment of the mobile multimode terminal according to the invention is advantageous in that an output of said joint power amplifier 9 is coupled to said joint antenna 41 via a first mode switch 1 and a second mode switch 5.

By introducing two mode switches 1,5 between the output of the joint power amplifier 9 and the joint antenna 41, the mobile multimode terminal can distinguish (switch) between both modes and couple one joint power amplifier 9 to one joint antenna 41 via different ways (duplexer 7 for the FDD mode and time slot switch 3 for the TDD mode).

A third embodiment of the mobile multimode terminal according to the invention is advantageous in that, in said first frequency division mode, main contacts of both mode switches 1,5 are coupled to each other via a first filter 6 and a duplexer 7, with, in said second time division mode, main contacts of both mode switches 1,5 being coupled to each other via a second filter 2 and a time slot switch 3.

The first filter 6 is for example a bandpass filter having a bandwidth of for example 3.84 MHz, with said duplexer 7 allowing the transmitting and receiving in said first frequency division mode. The second filter 2 is for example a bandpass filter having a bandwidth of for example 1.28 MHz, with said time slot switch 3 allowing the selection of transmitting time slots and of receiving time slots in said second time division mode.

A fourth embodiment of the mobile multimode terminal according to the invention is advantageous in that an input of said joint power amplifier 9, in said first frequency division mode, is coupled to an output of a joint pre-amplifier 23 via a third filter 11, a first mixer 15 and a third mode switch 18, with said input of said joint power amplifier 9, in said second time division mode, being coupled to said output of said joint pre-amplifier 23 via a fourth filter 10, a second mixer 14 and said third mode switch 18.

The third filter 11 is for example a bandpass filter having a bandwidth of for example 3.84 MHz, and the fourth filter 10 is for example a bandpass filter having a bandwidth of for example 1.28 MHz. The third mode switch 18 allows the use of said joint pre-amplifier 23 for both transmitters. By introducing one joint pre-amplifier 23 for both transmitters, compared to the situation where there are two pre-amplifiers—one for each transmitter—now one pre-amplifier is saved, which makes the mobile multimode terminal even more low cost.

A fifth embodiment of the mobile multimode terminal according to the invention is advantageous in that said mobile multimode terminal comprises at least a first receiver 8,12,16,21 for receiving third signals in said first frequency division mode and a second receiver 4,13,17,22 for receiving fourth signals in said second time division mode, with an input of said first receiver being coupled to said joint antenna 41 via said duplexer 7 and said first mode switch 1, and with an input of said second receiver being coupled to said joint antenna 41 via said time slot switch 3 and said first mode switch 1.

For receiving said third and fourth signals, the first mode switch 1 allows the distinguishment (switching) between both modes, with said duplexer 7 and said time slot switch 3 allowing the distinguishment (switching) between transmitting and receiving.

A sixth embodiment of the mobile multimode terminal according to the invention is advantageous in that outputs of said first and second receivers are coupled to an input of a joint variable gain amplifier 26.

Both receivers are down-converted to for example the same Intermediate Frequency (IF). By introducing one joint variable gain amplifier 26 for both receivers, compared to the situation where there are two variable gain amplifiers—one for each receiver—now one variable gain amplifier is saved, which makes the mobile multimode terminal even more low cost.

A seventh embodiment of the mobile multimode terminal according to the invention is advantageous in that each receiver comprises a serial circuit of a low noise amplifier 12/13 and a mixer 16/17 located between filters 8,21/4,22.

Both filters 8,21 in a first serial circuit for the frequency division mode are for example bandpass filters having a bandwidth of for example 3.84 MHz, and both filters 4,22 in a second serial circuit for the time division mode are for example bandpass filters having a bandwidth of for example 1.28 MHz. In each serial circuit, the filter coupled to the low noise amplifier, inter alia, for example filters image frequency components, and the filter coupled to the mixer, inter alia, for example filters intermodulation components.

A eighth embodiment of the mobile multimode terminal according to the invention is advantageous in that each mixer is coupled to a Phase Locked Loop system 19,20,24,25.

By introducing one joint Phase Locked Loop system 19,20,24,25 for both transmitters as well as for both receivers, the efficiency of the mobile multimode terminal is further increased.

A ninth embodiment of the mobile multimode terminal according to the invention is advantageous in that said Phase Locked Loop system 19,20,24,25 comprises at least two Phase Locked Loops 19,20, with each Phase Locked Loop 19/20 being coupled to mixers 15,16/14,17.

A first Phase Locked Loop 20 for example supplies mixer 14 in the second transmitter and mixer 17 in the second receiver in the time division mode, and for example supplies mixer 16 in the first receiver in the frequency division mode, and second Phase Locked Loop 19 for example supplies mixer 15 in the first transmitter in the frequency division mode.

The invention is based upon an insight, inter alia, that both modes (can) use the same, overlapping, neighboring and/or nearby frequency bands, and is based upon a basic idea, inter alia, that one joint power amplifier 9 can be used in case of both modes not being active at the same moment.

The invention solves the problem, inter alia, of providing a low cost mobile multimode terminal, by deleting, of two or more power amplifiers, one or more power amplifiers which are superfluous.

Said mobile multimode terminal as shown in FIG. 1 will further comprise a processor not shown for controlling said terminal and for generating, for example, said mode control signal having said first (FDD mode) or second (TDD mode) value. Thereto, for example, a user of said terminal selects an option, resulting in said generating, or said processor generates at predefined moments in time said values, resulting in said terminal for example selecting a mode and/or checking which mode at the moment is (best) to be used. Or, for example, said terminal is in one of both modes and then receives via said joint antenna a signal indicative for requesting/ordering the switching into the other mode, etc.

In case of said terminal being in the first (FDD) mode, for example speech signals to be transmitted are modulated by modulator 28, amplified by joint pre-amplifier 23, up-converted by mixer 15, filtered by filter 11, amplified by joint amplifier 9, filtered by filter 6, and transmitted as first signals via duplexer 7 and mode switch 1 and joint antenna 41. Third signals like for example modulated speech signals originating from a base station not shown are received via joint antenna 41, mode switch 1, duplexer 7 and then filtered by filter 8, low-noise-amplified by low noise amplifier 12, down-converted by mixer 16 and filtered by filter 21, amplified by joint variable gain amplifier 26 and then demodulated by demodulator 31.

In case of said terminal being in the second (TDD) mode, for example speech signals to be transmitted are modulated by modulator 28, amplified by joint pre-amplifier 23, up-converted by mixer 14, filtered by filter 10, amplified by joint amplifier 9, filtered by filter 2, and transmitted as second signals via time slot switch 3 and mode switch 1 and joint antenna 41. Fourth signals like for example modulated speech signals originating from a base station not shown are received via joint antenna 41, mode switch 1, time slot switch 3 and then filtered by filter 4, low-noise-amplified by low noise amplifier 13, down-converted by mixer 17 and filtered by filter 22, amplified by joint variable gain amplifier 26 and then demodulated by demodulator 31.

In the first (FDD) mode, the chip rate is about 3.84 MBPS, the transmission band is about 1920-1980 MHz and the receiving band is about 2110-2170 MHz. Thereby, second PLL 19 supplies mixer 15 and is used for said transmission and operates in the 1920-1980 MHz band, and first PLL 20 supplies mixer 16 and is used for said receiving and operates in the 2110-2170 MHz band. In the second (TDD) mode, the chip rate is about 1.28 MBPS, and the transmission band as well as the receiving band both use 1900-1920 MHz and 2010-2015 MHz, with usually (but not exclusively) the same frequency being used for transmission as well as receival. Thereby, first PLL 20 supplies both mixers 14,17 operating in said 1900-1920 MHz and 2010-2015 MHz bands. Due to these four bands being so close to one another, one joint power amplifier and one joint antenna can be used.

Said processor not shown will further generate, in addition to said mode control signal to be supplied to said mode switches, for example, one or more transmission power control signals to be supplied to said joint power amplifier and to said joint pre-amplifier for controlling the transmission power, and will further generate, for example, one or more automatic gain control signals to be supplied to said joint variable gain amplifier for controlling the gain in a receiver system comprising both receivers, and will further generate, for example, one or more frequency control signal to be supplied to said PLLs in said PLL system for controlling said PLLs and/or said source for allowing said up-converting, modulating, down-converting and demodulating towards/from the before-mentioned frequency bands. So, PLLs 19 and 20 are so-called Radio Frequency PLLs or RF PLLs, with PLL 25 being a so-called Intermediate Frequency PLL or IF PLL.

The minimum configuration of transmitter system 42 according to the invention comprises a first transmitter minimally comprising joint power amplifier 9 and mode switch 5 and filter 6 and comprises a second transmitter minimally comprising joint power amplifier 9 and mode switch 5 and filter 2. Additionally, said transmitter system 42 according to the invention may further comprise one or more of filters 10,11, of mixers 14,15, of mode switch 18, of joint pre-amplifier 23, of time slot switch 3, of duplexer 7, of mode switch 1 and/or of antenna 41.

Instead of using one mode control signal for three mode switches, two or more mode control signals could be used, like for example one specific mode control signal for each specific mode switch. Further, said mode control signal(s) may have more than two possible values, and said terminal may have more than two possible modes. Said terminal may be a third generation mobile phone, but is not limited to mobile telephony, and may also be used for other signals than speech signals, like for example video signals or (general) data signals.

1. Mobile multimode terminal for use in at least a first frequency division mode and a second time division mode and comprising at least a first transmitter (6,5,9,11,15,18,23) for transmitting first signals in said first frequency division mode and a second transmitter (2,5,9,10,14,18,23) for transmitting second signals in said second time division mode, characterized in that said first and second transmitters comprise a joint power amplifier (9) for amplifying said first and second signals.

2. Mobile multimode terminal according to claim 1, characterized in that said first and second transmitters are coupled to a joint antenna (41).

3. Mobile multimode terminal according to claim 2, characterized in that an output of said joint power amplifier (9) is coupled to said joint antenna (41) via a first mode switch (1) and a second mode switch (5).

4. Mobile multimode terminal according to claim 3, characterized in that, in said first frequency division mode, main contacts of both mode switches (1,5) are coupled to each other via a first filter (6) and a duplexer (7), with, in said second time division mode, main contacts of both mode switches (1,5) being coupled to each other via a second filter (2) and a time slot switch (3).

5. Mobile multimode terminal according to claim 4, characterized in that an input of said joint power amplifier (9), in said first frequency division mode, is coupled to an output of a joint pre-amplifier (23) via a third filter (11), a first mixer (15) and a third mode switch (18), with said input of said joint power amplifier (9), in said second time division mode, being coupled to said output of said joint pre-amplifier (23) via a fourth filter (10), a second mixer (14) and said third mode switch (18).

6. Mobile multimode terminal according to claim 5, characterized in that said mobile multimode terminal comprises at least a first receiver (8,12,16,21) for receiving third signals in said first frequency division mode and a second receiver (4,13,17,22) for receiving fourth signals in said second time division mode, with an input of said first receiver being coupled to said joint antenna (41) via said duplexer (7) and said first mode switch (1), and with an input of said second receiver being coupled to said joint antenna (41) via said time slot switch (3) and said first mode switch (1).

7. Mobile multimode terminal according to claim 6, characterized in that outputs of said first and second receivers are coupled to an input of a joint variable gain amplifier (26).

8. Mobile multimode terminal according to claim 7, characterized in that each receiver comprises a serial circuit of a low noise amplifier (12/13) and a mixer (16/17) located between filters (8,21/4,22).

9. Mobile multimode terminal according to claim 8, characterized in that each mixer is coupled to a Phase Locked Loop system (19,20,24,25).

10. Mobile multimode terminal according to claim 9, characterized in that said Phase Locked Loop system (19,20,24,25) comprises at least two Phase Locked Loops (19,20), with each Phase Locked Loop (19/20) being coupled to at least one mixer (15/14,16,17).

11. Transmitter system (42) for use in a mobile multimode terminal for use in at least a first frequency division mode and a second time division mode, which mobile multimode terminal comprises said transmitter system (42) comprising at least a first transmitter (6,5,9,11,15,18,23) for transmitting first signals in said first frequency division mode and a second transmitter (2,5,9,10,14,18,23) for transmitting second signals in said second time division mode, characterized in that said transmitter system (42) comprises a joint power amplifier (9) for amplifying said first and second signals.

12. Method for use in a mobile multimode terminal for use in at least a first frequency division mode and a second time division mode, which method comprises the steps of transmitting first signals in said first frequency division mode and of transmitting second signals in said second time division mode, characterized in that said method comprises the step of amplifying said first and second signals by using a joint power amplifier.
